(19) United States
(12) Patent Application Publication
(10) Pub. No.: US 2006/0055155 A1
(43) Pub. Date: Mar. 16, 2006

(54) Fastening device, in particular for occupant restraint systems of motor vehicles

(75) Inventors: Ralph Frisch, Moembris (DE); Claudia Szidzek, Obernburg (DE); Michael Schneider, Sulzbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/215,925

(22) Filed: Aug. 31, 2005

(30) Foreign Application Priority Data
Sep. 16, 2004 (DE) 20 2004 014 451.4

(51) Int. Cl. B60R 21/16

(52) U.S. Cl. 280/728.2

(57) ABSTRACT

A fastening device, in particular for occupant restraint systems of motor vehicles includes a first connecting element which has tongues (24) able to be twisted in a plastic manner, each tongue (24) having a rotary lug (27), and a second connecting element which has cut-outs (29) through which the rotary lugs (27) of the tongues (24) can be passed. The second connecting element has positioning means (28) in a region of the cut-outs (29), which hold the rotary lugs (27) of the first connecting element in a twisted position after the twisting of the tongues (24).

### TECHNICAL FIELD

The invention relates to a fastening device, in particular for occupant restraint systems of motor vehicles.

### BACKGROUND OF THE INVENTION

Such fastening devices are known from the prior art and are used for example in the DE 101 53 861 A to secure a generator carrier in a housing of a gas bag module. For this, slits are provided in the housing of the gas bag module, through which fastening tongues provided on the generator carrier can be passed. Each fastening tongue is connected via a narrow cross-piece to a base section of the generator carrier. The narrow cross-pieces make it possible to turn the fastening tongues after passing through the slits, so that the generator carrier is fastened in the module housing.

### BRIEF SUMMARY OF THE INVENTION

According to the invention, a fastening device, in particular for occupant restraint systems of motor vehicles, includes a first connecting element which has tongues able to be twisted in a plastic manner, each tongue having a rotary lug, and a second connecting element which has cut-outs through which the rotary lugs of the tongues can be passed. The second connecting element has positioning means in a region of the cut-outs, which hold or secure the rotary lugs of the first connecting element in a twisted position after the twisting of the tongues. The positioning means therefore represent safety contrivances for the known fastening device and prevent the tongues from being twisted back and the connection from being detached.

Preferably, the lugs and the positioning means engage each other in a form-fitting manner. The positioning means can be constructed as detent means in which the rotary lugs engage. Detent means are known as a simple and effective possibility for securing components in position and in this case also represent favorably priced positioning means for securing the connection.

In an embodiment, the positioning means are formed in one piece in the second connecting element. This offers the advantage that the number of individual components is reduced.

In a further embodiment, the tongues are constructed so that the first connecting element and the second connecting element are braced with each other after the twisting of the tongues. Therefore, friction sites and a noise development associated therewith can be avoided. Because of the two connecting elements having no play, an undesired rattling of the connecting elements in case of a vibration of the fastening device is also prevented.

The two connecting elements can be made of metal, which offers the advantage that the plastic twisting of the tongues and the forming of the positioning means in one piece is particularly readily possible.

In a further embodiment, the positioning means are formed by cold forming of the second connecting element. This variant is favorably priced, particularly when the positioning means are already formed in the process of shaping the connecting element.

Between the first connecting element and the second connecting element, a part can be clamped which is to be fastened. Thereby, a saving is made as regards additional fastening means, which leads both to a cost saving and also to a reduction in the number of individual components.

In a particular embodiment, the part which is to be fastened is a gas bag or a gas generator clamped between the connecting elements. In the triggering of occupant restraint systems of motor vehicles, high forces occur on the system components, in particular on the gas bag. The fastening device according to the invention offers a simple and, at the same time, reliable possibility for fastening the gas bag between two connecting elements in this case.

At least one of the connecting elements can be a gas bag holding frame, a generator carrier or a gas generator. For the connection of these highly stressed components of an occupant restraint system, the fastening device according to the invention offers, with a similar reliability of the connection, a smaller effort as a whole than traditional connections, for example screw connections.

### BRIEF DESCRIPTION OF THE DRAWINGS

FIG. 1 shows part of a gas bag module with a fastening device according to the invention in a perspective top view;

FIG. 2 shows a diagrammatic detail section view along the line II-II in

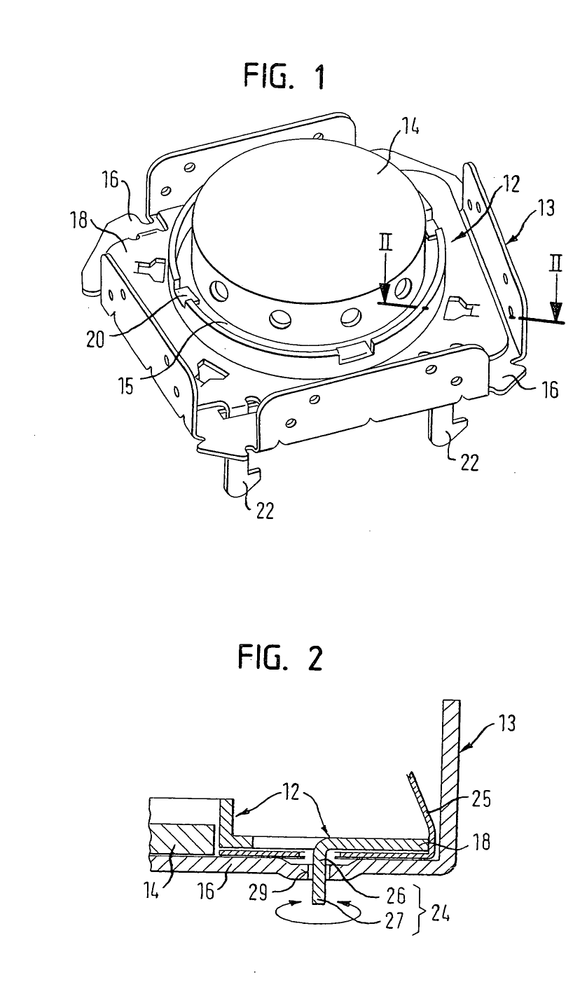

FIG. 1 with an additionally clamped gas bag;

FIG. 3 shows the assembly of FIG. 1 in a perspective lower view; and

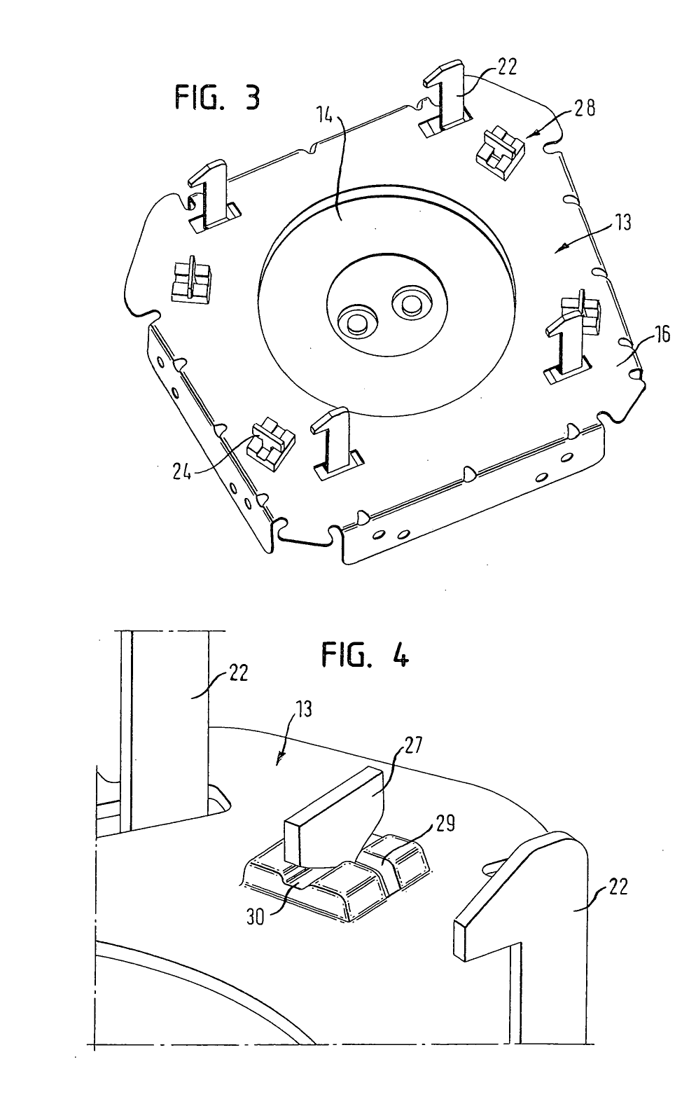

FIG. 4 shows a detail of the perspective lower view of FIG. 2 with already twisted tongues.

### DETAILED DESCRIPTION OF THE PREFERRED EMBODIMENT

FIG. 1 shows a gas bag module with a fastening device comprising a first connecting element, here a holding frame 12, a second connecting element, here a generator carrier 13, and a part to be fastened, here a gas generator 14. On the cylindrical gas generator 14, a generator flange 15 is formed, encircling the gas generator 14 on the edge side. The gas generator 14 is positioned on the generator carrier 13 so that the gas generator 14 covers a circular opening (see also FIG. 3) of a base plate 16 of the generator carrier 13. Here, the generator flange 15 lies on an edge of the circular opening in the base plate 16. The holding frame 12 has a base plate 18 with a further circular opening. This opening is situated in the centre of the base plate 18 and has a cylindrical edging with four radial projections 20. In addition, four hooks 22 on the edge of the base plate 18 are bent downwards for the further mounting of the fastening device. Furthermore, four tongues 24 are punched free from the base plate 18 of the holding frame 12 and are bent downwards (FIG. 2). In FIG. 1 only the gaps in the base plate 18 of the holding frame 12, occurring through the punching, can be seen. The holding frame 12 is arranged so that the gas generator 14 extends through the opening of the holding frame 12 and the projections 20 of the cylindrical edging of the holding frame 12 engage on the generator flange 15 so that the gas generator 14 is clamped between the projections 20 and the base plate 16. As illustrated in FIG. 1, the downwardly bent hooks 22 and the tongues 24 of the holding frame 12 extend through corresponding cutouts in the base plate 16 of the generator carrier 13.

FIG. 2 shows a detail of FIG. 1 in a section view along the line II-II. In addition, a possible arrangement of a further part which is to be fastened is illustrated in the section view. In FIG. 2, this further part which is to be fastened is a gas bag 25, that is clamped between the holding frame 12 and the generator carrier 13. The gas bag 25 has openings in a region of a gas bag orifice to lead through the hooks 22 and the tongues 24. For reasons of clarity, in the further Figures, an illustration of the gas bag 25 was dispensed with. The tongues 24 are constructed so that on punching out they remain connected with the base plate 18 of the holding frame 12 via a narrow cross-piece 26 and spread out to so-called rotary lugs 27 in the direction to their free ends. The sides of the rotary lug 27 facing the cross-piece 26 of the tongue 24 lie, with a twisting of the tongues 24, against a positioning means 28. Here, the positioning means 28 is formed in one piece as a depression in the generator carrier 13. Such an embodiment of the tongue 24 and the positioning means 28 is possible because the two connecting elements are made of steel plate.

FIGS. 3 and 4 show a perspective lower view of the fastening device of FIG. 1. The four tongues 24 of the holding frame 12 can be seen clearly, which extend through slit-shaped cutouts 29 in the base plate 16 of the generator carrier 13. The cutouts 29 in the base plate 16 are just large enough that the rotary lugs 27 can be guided through. In the region of the cutouts 29 for the tongues 24, the positioning means 28 can be seen in FIG. 3; in this case, they are square depressions formed out in the base plate 16 by cold forming. In a tangential direction in relation to the gas generator 14, the square depressions have the slit-shaped cutouts 29. Perpendicular to the slit-shaped cutouts 29, each square depression has a linear indentation 30 (cf. also FIG. 4).

FIG. 4 shows a detail of the perspective lower view of FIG. 3. Of course, the rotary lug 27 is already in a twisted position; i.e. the rotary lug 27 was already rotated through 90 degrees and therefore the cross-piece 26 of the tongue 24 was twisted in a plastic manner. In this case the positioning means 28 is constructed as a detent means because of the indentation 30 in the square depression of the generator carrier 13. Through the fact that the sides of the rotary lugs 27 facing the cross-piece 26 are chamfered, a bracing between the holding frame 12 and the generator carrier 13 occurs on twisting of the tongue 24 via the square depression of the base plate 16. This bracing therefore acts in the insertion direction of the tongue, i.e. axially. As a result of this axial tension, the rotary lug 27 engages in the indentation 30 of the square depression.

1. A fastening device, in particular for occupant restraint systems of motor vehicles, said fastening device comprising a first connecting element which has tongues (24) able to be twisted in a plastic manner with each tongue (24) having a rotary lug (27), and a second connecting element which has cutouts (29) through which said rotary lugs (27) of said tongues (24) can be passed, said second connecting element having positioning means (28) in a region of said cutouts (29), which hold said rotary lugs (27) of said first connecting element in a twisted position after the twisting of said tongues (24).

2. The fastening device according to claim 1, wherein said positioning means (28) and said lugs (27) engage each other in a form-fitting manner.

3. The fastening device according to claim 1, wherein said positioning means (28) are constructed as detent means in which said rotary lugs (27) can engage.

4. The fastening device according to claim 1, wherein said positioning means (28) are formed in one piece in said second connecting element.

5. The fastening device according to claim 1, wherein said tongues (24) are constructed such that said first connecting element and said second connecting element are braced with each other after the twisting of said tongues (24).

6. The fastening device according to claim 1, wherein said first and second connecting elements are made of metal.

7. The fastening device according to claim 1, wherein said positioning means (28) are formed by cold forming of said second connecting element.

8. The fastening device according to claim 1, wherein a part which is to be fastened is provided, said part being clamped between said first connecting element and said second connecting element.

9. The fastening device according to claim 8, wherein said part which is to be fastened is one of a gas bag (25) and gas generator (14) that is clamped between said connecting elements.

10. The fastening device according to claim 1, wherein at least one of said connecting elements is one of a gas bag holding frame (12), generator carrier (13) and gas generator (14).
